(19) United States
(12) Patent Application Publication
(10) Pub. No.: US 2002/0101920 A1
(43) Pub. Date: Aug. 1, 2002

(54) Automatic test data generating apparatus and method

(75) Inventors: Byoung-Ju Choi, Seoul (KR); Ki-wung Park, Suwon-city (KR); In-pyo Hong, Yongin-city (KR); Byoung-kyu Min, Seoul (KR); Sun-hwa Yeum, Seoul (KR)

Correspondence Address: SUGHRUE, MION, ZINN, MACPEAK & SEAS, PLLC, 2100 Pennsylvania Avenue, NW, Washington, DC, 20037-3213, US

(73) Assignee: SAMSUNG ELECTRONICS CO., LTD

(21) Appl. No.: 09/866,475

(22) Filed: May 29, 2001

(30) Foreign Application Priority Data
Oct. 26, 2000 (KR) 2000-63253

(51) Int. Cl. H04B 1/66

(52) U.S. Cl. 375/240; 348/384.1

(57) ABSTRACT

An automatic test data generating apparatus for automatically generating test data based on the input items of a user in order to test a digital TV application software environment (DASE) system and a method therefor. The automatic test data generating apparatus includes a database for storing at least information on raw data and the MPEG transport stream standard and a test data generator for generating test data corresponding to the input items of the user based on the input items of the user and information on the raw data and the MPEG transport stream standard. Accordingly, the time and expenses spent on generating test data for testing the DASE system are reduced and those who do not have special knowledge can generate the test data.

The present application is based on Korean Patent Application No. 2000-63253, which is incorporated herein by reference.

### BACKGROUND OF THE INVENTION

1. Field of the Invention

The present invention relates to automatic test data generating apparatus and method, and more particularly, to an automatic test data generating apparatus for automatically generating test data to test digital TV application software environment (DASE) systems, and a method therefor.

2. Description of the Related Art

A DASE system is a system for receiving broadcast data in the form of a moving picture experts groups transport stream (MPEG TS) and processing the received broadcast data. Test data for testing the DASE system is manually generated in a conventional technology. However, since the data processed by the DASE system has numerous combinations, it is difficult to generate data to test all permutations of data combinations. Therefore, it is necessary to select meaningful combinations among the combinations of the data.

When the meaningful combinations are manually selected, reliability of the generated test data deteriorates and it takes a long time and costs much money to generate the test data. Namely, the test data for testing DASE systems basically includes eight tables, which constitute program specific information (PSI) and program and system information protocol (PSIP), a table, which is necessary when a data service exists, and many other dependent tables. Each table includes ten or more data fields. Therefore, it is obvious that it would take much time and be expensive to manually select the meaningful tables and generate corresponding data values.

Also, since the data required has a complicated structure, only those who have special knowledge of processed data can generate the test data. Namely, the MPEG-2 transport stream standard includes numerous tables and each table includes various data fields. Each data field has its own rules and restrictions in obtaining values and has relations to other data fields. Therefore, it is difficult for those who do not have special knowledge of the MPEG-2 transport stream to generate the test data.

### SUMMARY OF THE INVENTION

To solve the above problems, it is an object of the present invention to provide an automatic test data generating apparatus for automatically generating test data to test a digital TV application software environment (DASE) system, and a method therefor.

It is another object of the present invention to provide an automatic test data generating apparatus for automatically generating test data which is suitable for the MPEG-2 transport stream standard, on the basis of the input items of a user in order to test the DASE system, and a method therefor.

It is another object of the present invention to provide an automatic test data generating apparatus for calculating the test data to test the DASE system in the form of a script file, and a method therefor.

Accordingly, to achieve the above objects, there is provided an automatic test data generating apparatus, comprising a database for storing at least information on raw data and the MPEG transport stream standard and a test data generator for generating test data corresponding to the input items of the user based on the input items of the user and information on the raw data and the MPEG transport stream standard.

To achieve the above objects, there is provided a method for generating test data, comprising (a) generating test data corresponding to information on input items based on information related to the raw data and the MPEG transport stream standard when the information on input items of the desired test data is input from a user and (b) outputting the generated test data in the form of a script file.

### BRIEF DESCRIPTION OF THE DRAWING(S)

The above objects and advantages of the present invention will become more apparent by describing in detail a preferred embodiment thereof with reference to the attached drawings in which:

FIG. 1 is a block diagram showing an automatic test data generating apparatus according to the present invention;

FIG. 2 is a detailed block diagram showing the test data generator shown in FIG. 1;

FIG. 3 is a flowchart showing the operation of a method for automatically generating test data according to the present invention;

FIG. 4 is a flowchart showing processes of generating the table structure of the test data in the method for automatically generating test data according to the present invention; and

FIG. 5 is a flowchart showing the processes of generating the table value of the test data in the method for automatically generating test data according to the present invention.

### DESCRIPTION OF THE PREFERRED EMBODIMENT(S)

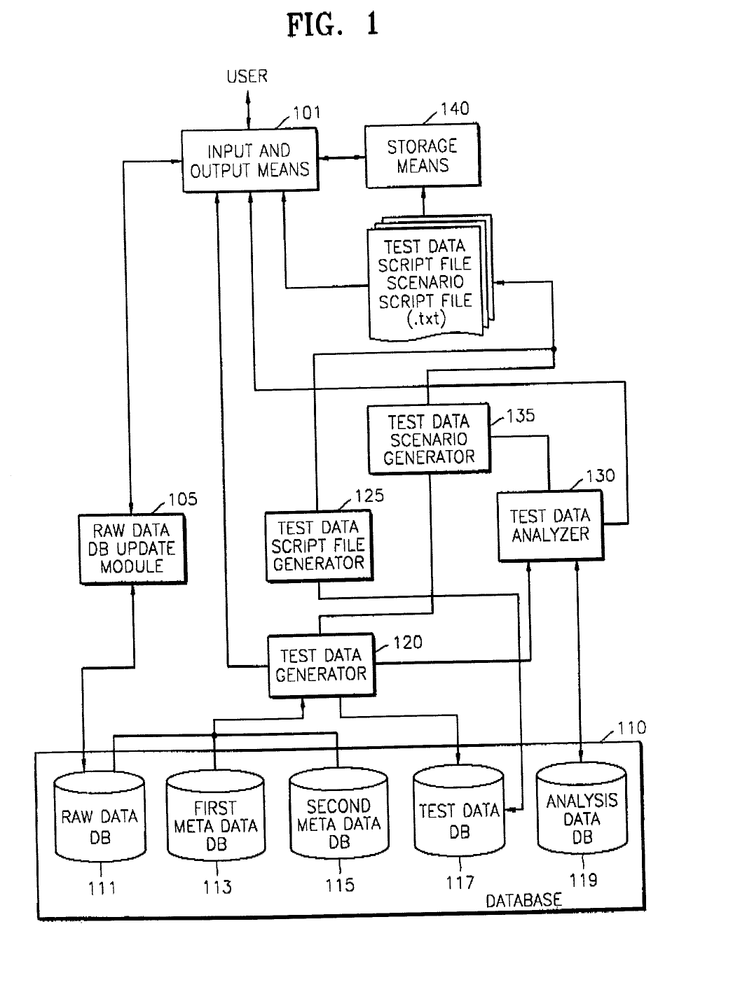

FIG. 1 is a block diagram showing the operation of an automatic test data generating apparatus according to the present invention. The apparatus includes input and output means 101, a raw data DB update module 105, a database 110, a test data generator 120, a test data script file generator 125, a test data analyzer 130, a test data scenario generator 135, and storage means 140. The test data automatic generation apparatus is also referred to as an automatic test data generation tool (TDGT).

The input and output means 101 allows input of information on raw data to be updated and user request items for generating test data and allows output of a test data script file, a test data scenario file, test data analysis results, and coverage so that a user can see them. The user is the one who wishes to test an arbitrary digital TV application software environment (DASE) system.

The raw data DB update module 105 can update the raw data stored in a raw data DB 111 to be described later using the raw data input through the input and output means 101. The raw data, which is not processed, is an actual broadcasting signal. Therefore, since the raw data cannot be automatically generated, when the raw data, from which the user can obtain desired test data, is not stored in the raw data DB 111, the user must input the corresponding raw data through the input and output means 101. When the corresponding raw data is input, the raw data DB update module 105 updates the raw data DB 111 based on the input raw data.

At this time, the raw data DB update module 105 can provide guidance information so that the user can easily update the raw data DB. Namely, when the raw data DB is to be updated, the user can receive a corresponding input window through the input and output means 101 so as to input the information of a desired table.

The database 110 includes the raw data DB 111, first and second Meta data DBs 113 and 115, a test data DB 117, and an analysis data DB 119.

The raw data DB 111 is a database where the above-mentioned raw data is stored. As mentioned above, since an actual broadcasting signal cannot be automatically generated, the data is stored in the raw data DB 111. The raw data DB 111 can be updated by the user. The data, which forms the raw data DB 111, is divided into channel data and DTV program content data. The DTV program content data includes an event and a data service.

Detailed contents of the MPEG-2 transport stream standard and information on the attribute type of an automatic test data generation function are stored in the first and second Meta data DBs 113 and 115. The attribute type includes the identification number and order of generation of the test data automatic generation function.

The first Meta data DB 113 is referred to when the test data generator 120 generates the value of the test data. The specification of the MPEG-2 TS standard, the attribute type, and the identification number function_id of the automatic test data generation function are stored in the first Meta data DB 113. The MPEG-2 TS standard specification includes an identifier ID, a field name field_name, a type, bits, a minimum valid value valid_min, a maximum valid value valid_max, and a fixed value. The attribute type information includes the test data value generation order.

The second Meta data DB 115 is referred to when the test data generator 120 automatically generates the structure of the test data. Information on relations between tables, which constitute the test data (for example, a dependent table flag dependent_table_flag), a field name field_name, and the identification number function_id of the automatic test data structure generation function are stored in the second Meta data DB 115.

The test data DB 117 is a database for arbitrarily storing the test data generated by the TDGT according to the present invention. The generated test data is created in the form of a text file by the test data script file generator 125 and is subsequently deleted.

The analysis data DB 119 is a database for storing the results obtained by analyzing the test data generated by the test data analyzer 130. It is possible to store the analysis result for a certain period in order to calculate the test data analysis results accumulated at the request of the user.

The test data generator 120 generates the test data with reference to the database 110. Namely, the test data generator 120 converges a plan for forming the test data based on the input items of the user, which are input through the input and output means 101. Accordingly, the raw data, which forms the broadcast content is extracted from the raw data DB 111. The structure of the test data generated with reference to the second Meta data DB 115 is generated. The corresponding test data is automatically generated to be suitable for the MPEG-2 TS standard with reference to the first Meta data DB 113 according to the structure of the generated test data. When the structure and value of the test data is generated, the identification number of the automatic generation function stored in the first Meta data DB 113 is read and the read identification number is called and processes of generating the structure and value of the test data are executed.

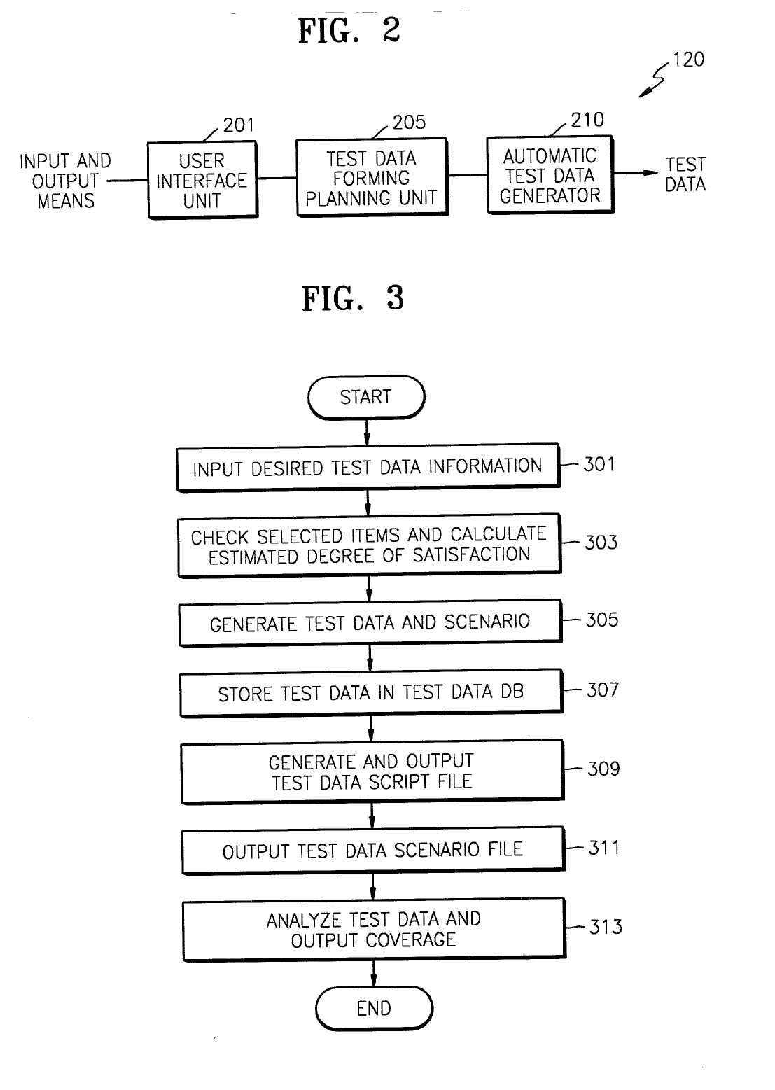

In order for the apparatus to operate as described above, the test data generator 120 includes a user interface unit 201, a test data forming planning unit 205, and an automatic test data generating unit 210, as shown in FIG. 2.

The user interface unit 201 receives the user input items, on which a plan for the content of the test data is based, from input and output means 101 for the test data generator 120 to automatically generate the test data.

The test data forming planning unit 205 establishes the channel information of the test data, a plan for the broadcast time, and the contents of the broadcast with reference to the raw data DB 111 based on the input items of the user, which are received by the test data generator 120.

The automatic test data generating unit 210 automatically generates the test data according to the plan for forming the test data, which is established based on the user input items.

The test data analyzer 130 analyzes the test data generated by the test data generator 120 in many aspects and outputs the analysis result to the input and output means 101 in the form of a table or a chart so that the user can see the results. At this time, it is possible to provide the results obtained by analyzing the currently generated test data and the accumulated analysis result of the test data items, which were generated.

The test data scenario generator 135 generates a scenario according to the generation of test data. The generated scenario includes the input items of the user, items determined by the test data generator 120, and the results obtained by analyzing the generated test data. The test data scenario file is calculated in the form of a script file in text format. The calculated test data scenario script file is directly output so as to be seen by the user through the input and output means 101 or is stored in the storage means 140.

The test data script file generator 125 extracts the test data generated by the test data generator 120 with reference to the test data DB 117. The extracted test data is generated as a script file. At this time, the test data script file generator 125 can provide a function of reading and editing the script file using the editor provided by the TDGT according to the present invention. The generated test data script file is in text format. The script file of the resulting test data is directly output so as to be seen by the user through the input and output means 101 or is stored in the storage means 140.

The test data script file and the scenario script file, which are stored in the storage means 140 can be output according to commands input through the input and output means 101. At this time, the output test data script file and scenario script file can be transmitted so as to be input to an encoder (not shown) included in the DASE system.

FIG. 3 is a flowchart showing the operation of the method for automatically generating the test data according to the present invention.

Referring to FIG. 3, a user wishing to test the DASE system inputs the information of the desired test data through the input and output means 101 in step 301. The items, which can be input by the user, include basic input items and input items for the module test of the DASE system. The basic input items include service type service_type, syntax, protocol, data service level data_service_level, section length section_length, and block size block_size. A DASE system input item includes the name of the module of the DASE system to be tested.

The user confirms the selected items and the estimated degree of satisfaction is calculated and shown when the test data desired by the user is generated in step 303. Such an operation is performed by the test data generator 120. Namely, the items input by the user using the user interface portion 201 are returned to the input and output means 101 so that the user can check the items. When the above degree of satisfaction is calculated based on input items according to the operation, which is previously set by the test data forming planning portion 205, the degree of satisfaction is output to the input and output means 101 through the user interface portion 201 so that the user can check the degree of satisfaction.

The test data generator 120 generates test data based on the input items of the user, in step 305. At this time, after the test data structure is automatically generated with reference to the raw data DB 111 and the first and second Meta data DBs 113 and 115, the values of the test data are generated.

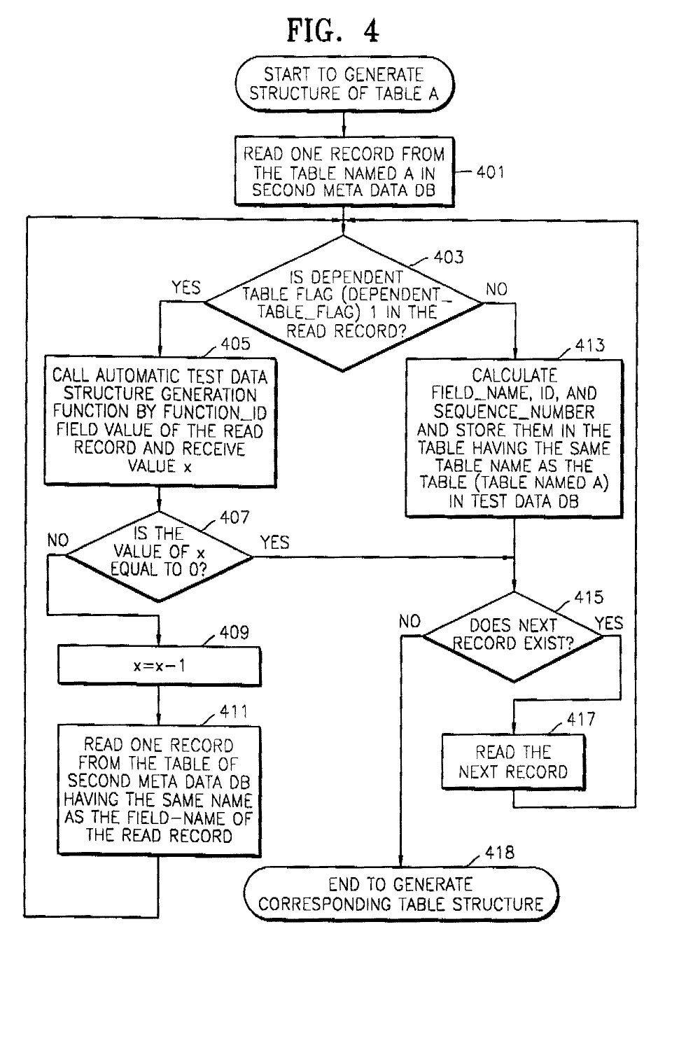

The automatic generation of the test data structure is shown in FIG. 4. FIG. 4 shows a case where the structure of the table named A among the test data items is automatically generated.

Namely, a record is read from the table named A from the second Meta data DB 115 in step 401. Then in step 403, a determination is made as to whether a dependent table flag dependent_table_flag is 1 from the read record. This is to determine whether the dependent table of the corresponding table can be extended. If the dependent table flag is 1, the dependent table of the corresponding table can be extended. The automatic test data structure generation function is called by the field value of the identification number function_id of the read record and the value x is returned in step 405. The value x shows how many times the corresponding dependent table must be inserted.

In step 407, the returned value of x is checked to determine if it is 0. If the value of x is not 0, the corresponding dependent table must be further inserted. Therefore, after the value obtained by subtracting 1 from the value of x is set to be the value of x in step 409, one record having the same name as the field name of the record, which is read next time, is read from the table stored in the second Meta data DB 115 in step 411. The process is returned to step 403.

When the dependent table flag of the read record is not determined to be 1 in step 403, a field name, ID, and a sequential number are calculated and stored in the tables having the same name in the test data DB 117 in step 413. In step 415, a check is made as to whether a next record exists. If it is determined that a next record does not exist, the generation of the corresponding table structure is completed. However, if a next record exists, the next record is read in step 417 and the process returns to step 403.

If it is determined in step 407 that the value of x is 0, the process proceeds to step 415 and a check is made as to whether the next record exists as described above.

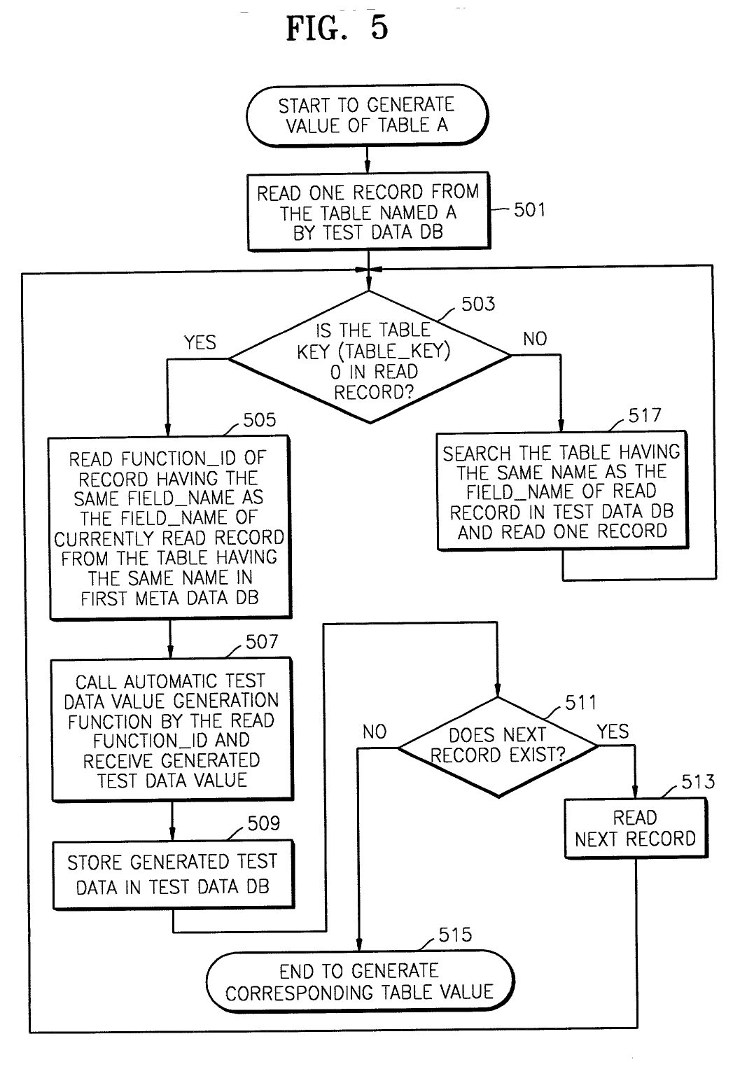

The processes of automatically generating the test data value are shown in FIG. 5. FIG. 5 shows a case where the value of the table A of arbitrary test data is generated, as shown in FIG. 4.

Referring to FIG. 5, in order to automatically generate test data values, one record is read from the table named A by the test data DB 117 in step 501. A check is made as to whether the value of the table_key table key is 0 in the read record in step 503.

When the table key is 0 and the record indicates a simple data field, the identification number function_id of the record having the same field name as the field name of the currently read record is read from the table named A in the first Meta data DB 113, in step 505. The automatic test data value generation function is called by the read identification number function_id and the generated value is returned as the test data in step 507.

The generated test data is stored in the test data DB 117 in step 509. In step 511, a check is made as to whether a next record exists. If a next record does not exist, the generation of values of the corresponding table is completed in step 515. However, if a next record exists, the next record is read in step 513 and the process is returned to step 503.

If the value of the table key is not 0 in the read record in step 503, a jump is made to the dependent table. Therefore, the table having the same name as the field name of the read record in step 517 is searched in the test data DB 117 and one record is read and the process is returned to step 503.

In step 305, as shown in FIG. 3, the TDGT, according to the present invention, generates a scenario with respect to main items over the entire process from the user (or a tester) who inputs the input items until the TDGT generates the test data and calculates coverage. The above-mentioned main items include the identification number and the generation time of the test data, test input items, TDGT determination items, and coverage analysis items.

In step 307 of FIG. 3, the TDGT, according to the present invention, stores the test data generated in step 305 to the test data DB 117.

In step 309, the generated test data, which is stored in the test data DB 117, is created to be the script file and is output so as to be seen by the user. At this time, the test script file can be edited using the editor provided by the TDGT.

The generated test data scenario file is output in step 311. The scenario is formed in a text file format and can be seen and edited using the editor provided by the TDGT.

In step 313, the TDGT according to the present invention provides the corresponding coverage to the user through the table and the chart by analyzing the coverage of the generated test data in various aspects. The basis of analyzing the test data can be divided into the variety of contents and the coincidence of the test input items. The input items with respect to the variety of contents include the variety of service types, the variety of protocols, the variety of test data contents, and the variety of syntaxes. The coincidence of the test input items include the coincidence of the service type, the coincidence of the protocol, the coincidence of the syntax, and the coincidence of the DASE system test.

According to the present invention, a user can test the upper module of the DASE system by generating test data for intensively testing one or more modules, which the user wishes to test.

According to the present invention, it is possible to reduce the time and expenses spent on generating test data by receiving only basic user input items and generating the test data within a short period of time.

According to the present invention, since the test data is generated without being interfered with by the user after receiving basic input items from the user, those who have no knowledge of the MPEG-2 transport stream standard can easily generate the test data.

Furthermore, according to the present invention, it is possible to easily generate various test data. Namely, according to the present invention, five kinds of basic input items are received from the user and it is possible to variously plan the contents of the test data, such as the content or time of the broadcast, based on basic input items. At this time, the contents of the broadcast are selected from the raw data DB, which can be continuously updated by the user. Therefore, since the kinds of test data which can be generated by the TDGT increase so that the contents of the raw data DB can be increased, it is possible to easily generate numerous test data as mentioned above.

What is claimed is:

1. An automatic test data generating apparatus, comprising:
a first database for storing at least information on raw data and a moving picture experts groups transport stream(MPEG TS) standard; and
a test data generator for generating test data corresponding to input items of a user based on the input items of the user and said at least information on the raw data and the MPEG transport stream standard.

2. The apparatus of claim 1, wherein the test data generator provides the generated test data to be stored in the database.

3. The apparatus of claim 2, further comprising a test data script file generator for generating the test data stored in the database in a form of a script file.

4. The apparatus of claim 1, further comprising a test data scenario generator for generating a scenario with respect to the generated test data when the test data is generated by the test data generator.

5. The apparatus of claim 4, wherein the scenario generator outputs the scenario in a form of a script file.

6. The apparatus of claim 1, further comprising a test data analyzer for analyzing the test data generated by the test data generator, according to a predetermined standard.

7. The apparatus of claim 6, wherein the predetermined standard is set based on a variety of contents and a coincidence of test input items.

8. The apparatus of claim 6, wherein the test data analyzer provides analysis results to be stored in the first database.

9. The apparatus of claim 6, wherein the test data analyzer outputs analysis results in a form of a table or a chart.

10. The apparatus of claim 1, wherein the first database comprises a second database for storing the raw data, a third database for storing information on the MPEG transport stream standard, a fourth database for storing the test data generated by the test data generator, and a fifth database for storing results of analyzing the test data according to a predetermined standard.

11. The apparatus of claim 1, wherein the test data generator comprises:
a user interface for interfacing between the test data generator and means for inputting user input items so as to receive the input items of the user;
a test data forming planning unit for planning for forming the test data on the basis of the user input items when the user input items are input through the user interface; and
a test data automatic generator for generating the corresponding test data with reference to information on the MPEG transport stream standard and generating a structure of the test data with reference to said at least information on the raw data and the MPEG transport stream based on content planned in the test data forming planning unit.

12. A method for generating test data, comprising:
(a) forming a database based on information on raw data and a moving picture experts group transport stream (MPEG TS) standard;
(b) generating the test data corresponding to information on input items with reference to the database, when input item information on desired test data is input from a user; and
(c) outputting the generated test data.

13. The method of claim 12, further comprising:
(d) generating a scenario corresponding to the generated test data; and
(e) outputting the scenario.

14. The method of claim 12, further comprising (d) analyzing the generated test data according to a predetermined standard and outputting the analyzed test data.

15. The method of claim 14, wherein the predetermined standard comprises a variety of contents and a coincidence of test input items.

16. The method of claim 12, wherein the step (b) comprises:
(b1) planning for forming the test data on a basis of the input items of the user;
(b2) generating a structure of the test data with reference to the database; and
(b3) generating the test data, which is suitable for the MPEG transport stream standard, according to the structure of the test data.

17. The method of claim 16, wherein the step (b2) comprises:
(b2-1) reading one record from a predetermined table of one or more tables included in Meta data, which exists in the database;
(b2-2) checking whether a dependent table of the predetermined table is extendable with reference to said one record;
(b2-3) checking a number of times of insertion of the dependent table by calling a test data structure automatic generation function with reference to said one record when the dependent table can be extended;
(b2-4) reading another record from the a table of said one or more tables included in the Meta data having a same field name as a field name of said one record, and returning to (b2-2) when the dependent table must be further inserted as a result of checking the number of times of insertion of the dependent table;
(b2-5) generating the test data structure of the predetermined table when the dependent table cannot be extended; and
((b2-6) executing steps ((b2-2) through ((b2-5) on other records in the predetermined table when it is determined that it is not necessary for the dependent table to be inserted further as a result of checking the number of times of insertion of the dependent table or when the step ((b2-5) is completed.

18. The method of claim 16, wherein the step (b3) comprises:
(b3-1) reading one record from a predetermined table of one or more tables included in the test data, which exists in the database;
((b3-2) checking whether the predetermined table is a simple data field with reference to information included in said one record;
((b3-3) calling an automatic test data value generation function with reference to Meta data, which exists in the database, and generating the test data with respect to the predetermined table when the predetermined table is a simple data field; and
((b3-4) reading another record from another table of said one or more tables included in the test data having a same field name as a field name of said one record, which exists in the database and returning to step ((b3-2) when the predetermined table is not a simple data field.

19. The method of claim 12, wherein the generated test data is in a form of a script file.

20. The method of claim 13, wherein the output scenario is in a form of a script file.
